(19) United States
(12) Patent Application Publication
(10) Pub. No.: US 2022/0216676 A1
(43) Pub. Date: Jul. 7, 2022

(54) FRAME FOR AN EXPLOSION-PROOF HOUSING

(71) Applicant: R. STAHL SCHALTGERÄTE GMBH, Waldenburg (DE)

(72) Inventor: Thorsten ARNHOLD, Pfedelbach (DE)

(21) Appl. No.: 17/611,877

(22) PCT Filed: May 5, 2020
(86) PCT No.: PCT/EP2020/062462

§ 371 Date: Nov. 16, 2021

(30) Foreign Application Priority Data
May 17, 2019 (DE) 10 2019 113 195.2

(51) Int. Cl. H02B 1/28; H02B 1/30

(52) U.S. Cl. CPC H02B 1/28; H02K 5/136; H02B 1/301

(57) ABSTRACT

A frame for explosion-proof housings. The frame is assembled from support elements. The support elements may be square tubes that are used as support elements, which are provided with elongated rectangular openings, which are closed by flameproof grilles that are welded on or fastened in another manner. The square tubes are joined to form a skeletal frame, which supports the housing structure (support frame). The metal plates may be stainless steel or aluminum, or plastic plates that are fastened to the outside of the frame by bonding and/or welding so that the housing is closed. Venting openings, which can be closed by the flameproof grilles, are provided in suitable locations of the housing, such as at the bottom or at the end faces. According to the present disclosure, thin wall thicknesses of the surface elements, for example plates, as well as large housing dimensions, while ensuring a flameproof enclosure, are made possible by means of the supporting and stabilizing support frame, which also helps to reduce the pressure.

### CROSS REFERENCE TO RELATED APPLICATIONS

This application is a National Stage application of PCT/EP2020/062462, filed on May 5, 2020, which claims the benefit of German Application No. 102019113195.2, filed on May 17, 2019, the contents each of which are incorporated herein by reference thereto.

### TECHNICAL FIELD

The invention relates to the field of explosion-proof housings.

### BACKGROUND

Explosion-proof housings are known from the prior art. For example, DE 10 2017 112 159 A1 discloses a housing comprising a housing wall including inner cavities, which contribute, on the one hand, to pressure relief of the interior space and, on the other hand, to an increase in the deformation resistance of the housing wall.

A need exists for housings that have thin wall thicknesses as well as large housing dimensions, while also ensuring a flameproof enclosure.

### BRIEF SUMMARY

Disclosed is a frame for an explosion-proof housing enclosing a housing interior space for accommodating operating equipment that can produce sparks, wherein the frame includes support elements, at least one of the support elements being a receiving support element and delimiting a support element interior space, and the receiving support element delimiting an opening by which the housing interior space is fluidically connected to the support element interior space.

Also disclosed is an explosion-proof housing comprising a frame, wherein the frame includes support elements, at least one of the support elements being a receiving support element and delimiting a support element interior space, and the receiving support element delimiting an opening by which the housing interior space is fluidically connected to the support element interior space.

Also disclosed is a method of making a frame, wherein the frame includes support elements, at least one of the support elements being a receiving support element and delimiting a support element interior space, and the receiving support element delimiting an opening by which the housing interior space is fluidically connected to the support element interior space, the method including the following steps: arranging the support elements to form the frame or at least a sub-structure of the frame, fastening the support elements, aligning the frame or the sub-structure of the frame, and connecting the support elements to fix an alignment of the frame or the sub-structure of the frame.

The explosion-proof housing for which the frame is intended is preferably designed according to the ‘flameproof enclosure’ explosion protection type. The housing encloses an interior space. Operating equipment can be arranged in the interior space. This equipment can produce sparks. In the event of an explosion occurring in the housing interior space, the housing is configured to release gas and/or particles from the housing if need be after having been cooled in such a way that the gas and/or the particles cannot ignite the atmosphere outside the housing.

The frame comprises support elements. The frame can be composed of elongated support elements, for example. Support elements of which the frame can be composed, for example, can be profiled sections, in particular hollow sections, such as square tubes. The support elements can in particular be horizontally arranged support elements, which form carriers or bars, and/or vertically arranged support elements, which form braces, and/or support elements which form struts and, for example, are diagonally arranged. At least some of the support elements preferably extend along the edges of the housing. Embodiments can comprise support elements that are frame-shaped themselves. These can, for example, be composed of hollow sections.

At least one of the support elements delimits a support element interior space. Such support elements can also be referred to as receiving support elements. The support elements are preferably hollow inside. At least one of the receiving support elements delimits an opening. As a result of the opening, the housing interior space is fluidically connected to the support element interior space of the receiving support element to reduce explosion pressure by venting burned and unburned gas from the housing interior space into the support element interior space.

The frame, which at least in embodiments can also be referred to as a skeleton carrier, on the one hand, has a supporting and stabilizing function for the entire housing design and, on the other hand, has the function of reducing pressure as a result of the support element interior space connected to the housing interior space. In this way, thin wall thicknesses as well as large housing dimensions are possible, while also ensuring the flameproof enclosure.

The frame preferably has a skeletal design composed of support elements and is three-dimensional. The frame can comprise lateral frame sections, which are assembled from elongated support elements, and, if necessary, elements for connecting the support elements, and which enclose a planar surface. In simple embodiments, these lateral frame sections can be formed of four elongated support elements which are oriented perpendicularly to one another and arranged in one plane.

Embodiments of the frame can be produced by means of embodiments of a modular system according to the invention. The modular system is characterized in that a plurality of (preferably three or more) frame types can be created using a certain number of different basic element types or basic module types, the frame types differing among one another in size.

The method according to the invention for producing the frame comprises the step of arranging support elements to form the frame or at least a sub-structure of the frame. The support elements are fastened, preferably to one another, so that subsequent alignment or iterative alignment with the attachment is possible. The frame or the sub-structure of the frame is aligned. The alignment of the frame or of the sub-structure is fixed by rigidly connecting the support elements. In this way, rough tolerances of the frame elements during the alignment can be compensated for.

Further preferred features or embodiments of the frame according to the invention, of the housing according to the invention, of the modular system according to the invention, as well as of the method according to the invention result from the following description:

In the frame, support element interior spaces of receiving support elements, that is, of the support elements that delimit a support element interior space, can be fluidically connected among one another. As a result of the connection, gas exchange is made possible between the support element interior spaces, preferably without the gas having to take a detour through the housing interior space, when flowing from one support element interior space to another support element interior space.

Support elements can be joined to form, with the support element interior spaces thereof, intermediate volumes that are contiguous in the support element interior spaces in the arrangement of connected support elements.

The connected support element interior spaces can form an unbranched channel or a channel that is branched once or multiple times, which serves as an absorption chamber for a pressure wave coming from the interior space of the housing. The channel can be used for the flameproof gas exchange between the housing interior space and the surrounding area of the housing. At least a portion of the channel cross-section is preferably free of porous material. This reduces the flow resistance through the channel so that, in the event of an explosion in the interior space of the housing, unburned gas or non-ignited gas is able to push, as a result of the expansion of ignited gas, from the interior space of the housing through the channel into the surrounding area, without resistance from material completely taking up the cross-section of the channel. Despite all this, the gas nonetheless has to be pushed out of the interior space against the resistance of the preferably flameproof elements that are used to close the openings to the interior space or the venting opening.

Not necessarily all of the receiving support elements have to delimit an opening by which the housing interior space is fluidically connected to the support element interior space.

The frame and/or the housing preferably establishes a venting opening by which the housing interior space is fluidically connected, preferably in a flameproof manner, if necessary indirectly via one or more support element interior spaces, or directly, to the surrounding area of the housing. In embodiments, the fluidic connection can only be open after a protective element has been destroyed or ruptured or released in another manner, for example a rupture disk or another protective body, which serves to shield the venting opening with respect to environmental influences such as dirt and/or moisture. When the venting opening is closed with a pressure relief body, the preferably present protective element can shield the pressure relief body against environmental influences to protect the pressure relief body from becoming clogged with dirt and/or moisture. While, in embodiments, the fluidic connection of the housing interior space via at least one support element interior space is always open to the surrounding area of the housing by way of the venting opening, the connection, in other embodiments, can be opened automatically during an explosion, for example as a result of a rupture disk being destroyed. In still other embodiments, the channel made of fluidically connected support element interior spaces is sealed with respect to the surrounding area of the housing, so that the channel absorbs gas in the event of an explosion, without giving it off to the surrounding area.

The venting opening can be closed in a flameproof manner by a pressure relief body, for example a grille or a grille system. A preferably present protective element can ensure that narrow pores of a flameproof pressure relief body also do not become clogged with dirt and/or liquid in a dirty, for example dust-laden, or moist environment. In embodiments, at least one support element, for example a support element that has one or no opening for the connection between the support element interior space and the housing interior space, can establish a venting opening. The venting opening established by the support element can, as described above, be closed by a pressure relief body, wherein the pressure relief body can be flameproof so as to close the venting opening in a flameproof manner. The venting opening established by the support element can be closed by a protective element, wherein the closure is opened in the event of an explosion in the interior space of the housing, or in the intermediate volume, as a result of the protective element being destroyed or ruptured due to the explosion, so as to expose the connection through the venting opening.

One or more support elements can comprise a, preferably flameproof, for example tubular, shell, by way of which the support element delimits the support element interior space, for example transversely to an extension direction, in particular a longitudinal extension direction, of the support element.

The opening in a receiving support element for the fluidic connection between the interior space of the housing and the support element interior space is preferably sealed with a gas-permeable pressure relief body. The pressure relief body does not necessarily have to close the opening in a flameproof manner. In embodiments, it is sufficient when the pressure relief body absorbs a portion of the kinetic energy and/or thermal energy of the gas flowing through the pressure relief body. The flameproof nature of a connection between the interior space of the housing and the surrounding area through the intermediate volume can be achieved by flameproof venting openings in such embodiments.

In other embodiments, the pressure relief body, however, can form a flame arrester in that the pressure relief body has open pores, for example, which form a flameproof gap. The opening in the receiving support element can be closed in a flameproof manner by such a pressure relief body. The pressure relief body can, for example, be formed by a grille or a grille system. As an alternative, the pressure relief body can, for example, be a random wire body, a metal or polymer foam, or the like.

When, in addition to the flameproof pressure relief bodies in the connection between the housing interior space and the intermediate volume, also the venting openings are closed in a flameproof manner, an explosion of the gas in the intermediate volume cannot completely roll over into the interior space of the housing, and also not into the surrounding area. When an explosion of the gas in the intermediate volume can be prevented, a flameproof nature of the venting openings may be dispensed with, if necessary, and only the connection between the interior space of the housing and the intermediate volume in the support elements can be flameproof.

“Closed in a flameproof manner” means that at least no gas or particles can pass through the flameproof closure, which have a temperature so that the gas or the particles can ignite an atmosphere behind the flameproof closure, in particular in the surrounding area of the housing.

The explosion-proof housing according to the invention comprises a frame according to the invention. Surface elements (these can also be referred to as closing elements) are preferably fastened to the frame to close the housing. The surface elements are preferably fastened to the outside of the frame.

Particularly preferably, plate-shaped surface elements are fastened to the housing to close the housing.

The surface elements can be welded and/or bonded to the frame, for example. Mutually abutting surface elements can be joined, in particular welded or bonded, to one another. In embodiments, the housing can, among other things, be closed in a flameproof manner in this way.

In preferred embodiments, at least two surface elements are seamlessly joined to one another in one piece. In preferred embodiments, the housing comprises at least one curved or folded plate for closing at least two sides of the housing. The sides preferably include an angle of 90°, for example. In this way, at least one elongated weld seam between two surface elements can be dispensed with.

The frame and the surface elements are preferably made of the same material. In this way, stresses due to changes in temperature can be avoided, since the frame and the plate material or the surface element material have the same thermal coefficient of expansion.

### BRIEF DESCRIPTION OF THE DRAWINGS

Further advantageous embodiments and features result from the dependent claims, the following description, and the figures.

In the drawings:

FIG. 1 shows an exemplary embodiment of a housing according to the invention;

FIG. 2 shows an exemplary embodiment of a frame according to the invention, for example of the housing according to the invention according to FIG. 1, in a perspective view;

FIG. 3 shows an exemplary embodiment of a support element according to the invention, as it can be used, for example, in the frame according to the invention according to FIG. 2, in a perspective view;

FIG. 4 shows the support element according to FIG. 3, comprising welded-on exemplary pressure relief bodies;

FIG. 5 shows a perspective view of the housing according to FIG. 1, with a view into the interior space with the cover removed;

FIG. 6 shows an exemplary embodiment of a cover by way of which the housing according to FIG. 1 can be closed, in a perspective view;

FIG. 7 shows a cross-sectional view through another exemplary embodiment of a support element;

FIG. 8 shows a cross-sectional view through yet another exemplary embodiment of a support element;

FIGS. 9a, 9b show illustrations of a method for producing surface elements of housings according to the invention;

FIGS. 10a to 10d show modules of an exemplary modular system;

FIG. 11a shows an example of a support frame, assembled from the modules according to FIGS. 10a to 10d;

FIG. 11b shows a sectional illustration through a section of the support frame according to FIG. 11b;

FIG. 12 shows an example of a housing comprising the support frame according to FIG. 11a;

FIGS. 13a to 13d show a modification of the modular system according to FIGS. 10a to 10d;

FIGS. 14a to 14g show another exemplary embodiment of a modular system according to the invention and an example of a support frame composed thereof;

FIG. 15a shows a frame according to another exemplary embodiment of a modular system;

FIGS. 15b to 15d show elements of the frame according to FIG. 15a or of the housing according to FIG. 15e;

FIG. 15e shows a housing designed with the frame according to FIG. 15a; and

FIG. 16 shows a flow chart of one example of a method according to the invention.

### DETAILED DESCRIPTION

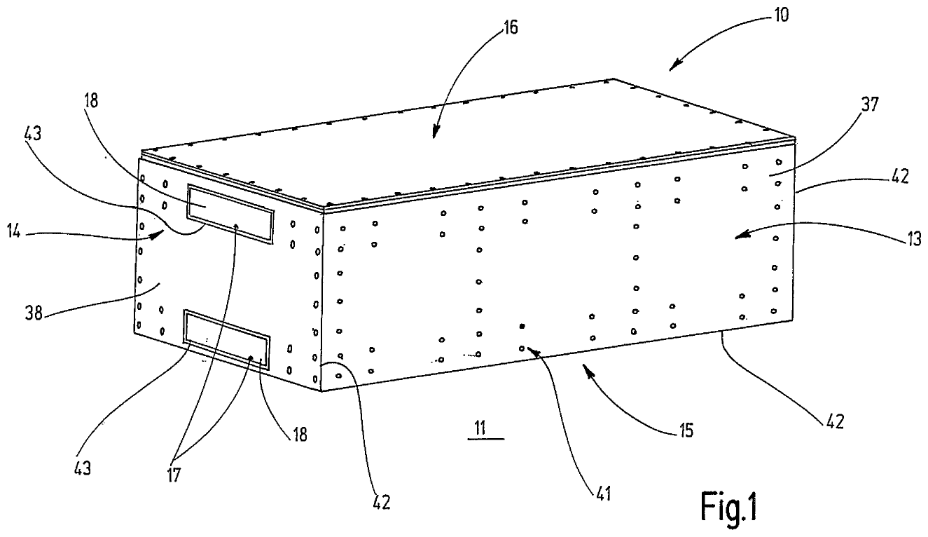

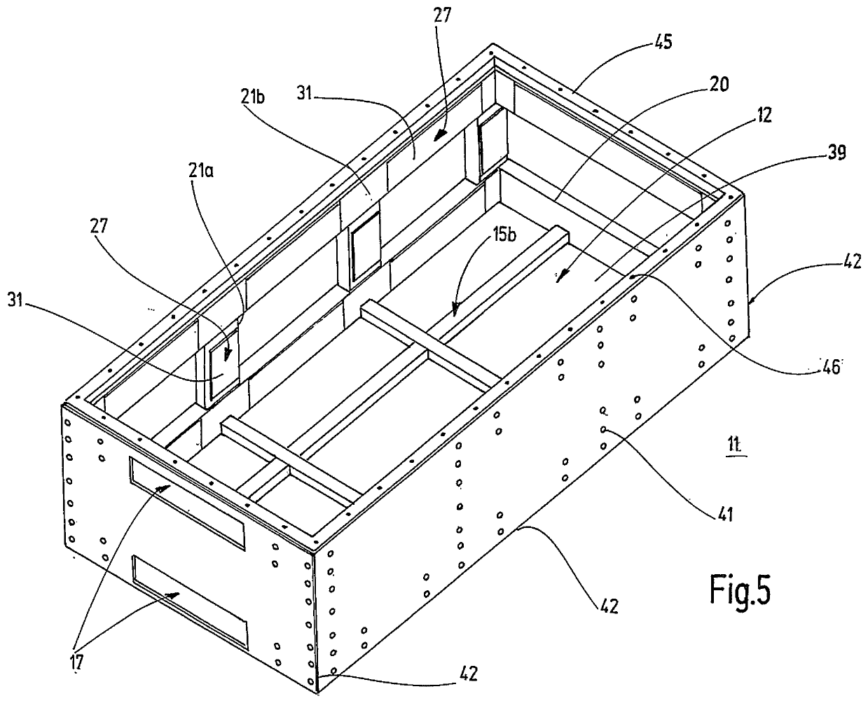

An exemplary embodiment of the explosion-proof housing 10 according to the invention is shown in FIG. 1, which is configured for use in a surrounding area 11 at risk of explosions. The housing 10 is used to accommodate components, for example electronic or electrical components, which can form sources of ignition for an explosive gas mixture during operation. The housing 10 surrounds an interior space 12 (see FIG. 5) in which the aforementioned components can be arranged. The housing 10 according to the invention is preferably designed according to the ‘flameproof enclosure’ protection type. This means that gas or particles do not necessarily have to be prevented from finding their way from the housing interior space 12 to the outside into the surrounding area 11 in the event of an explosion. However, gaps leading from inside the housing 10 to the outside have to be dimensioned in such a way that the gas cools, or the particles cool, sufficiently to prevent a potentially explosive atmosphere outside the housing 10 from being ignited. In the case of this ignition protection type, the surface temperature of the housing 10 also has to remain below the ignition temperature of the surrounding explosive atmosphere when an explosion occurs in the interior space of the housing 10 or when another (fault) event occurs. The housing 10 can in particular satisfy the standard EN 60079-1 (protection type Ex d) or, for example, a corresponding US standard.

As shown, the housing 10 according to the invention is preferably cuboidal. The housing comprises mutually opposing longitudinal sides 13, mutually opposing end faces 14, as well as a bottom 15 (or back), and a cover 16 (or front side). A venting opening 17 is preferably established in at least one side, for example the longitudinal side 13, end face 14, bottom 15 or cover 16. In the illustrated exemplary embodiment, two venting openings 17 are established in an end face 14. The exemplary embodiment according to FIGS. 1, 2 and 5 is shown lying on the back 15. When the housing 10 is set up vertically, the venting openings 17 are thus located at the top. The venting openings 17 are preferably each closed in a flameproof manner by a pressure relief body 18, which can have a grille structure, for example.

The housing interior space 12 can comprise a volume of at least several liters, for example at least 100 liters or at least 500 liters or even at least 1000 liters. In principle, however, this housing concept can also be used for smaller housings 10.

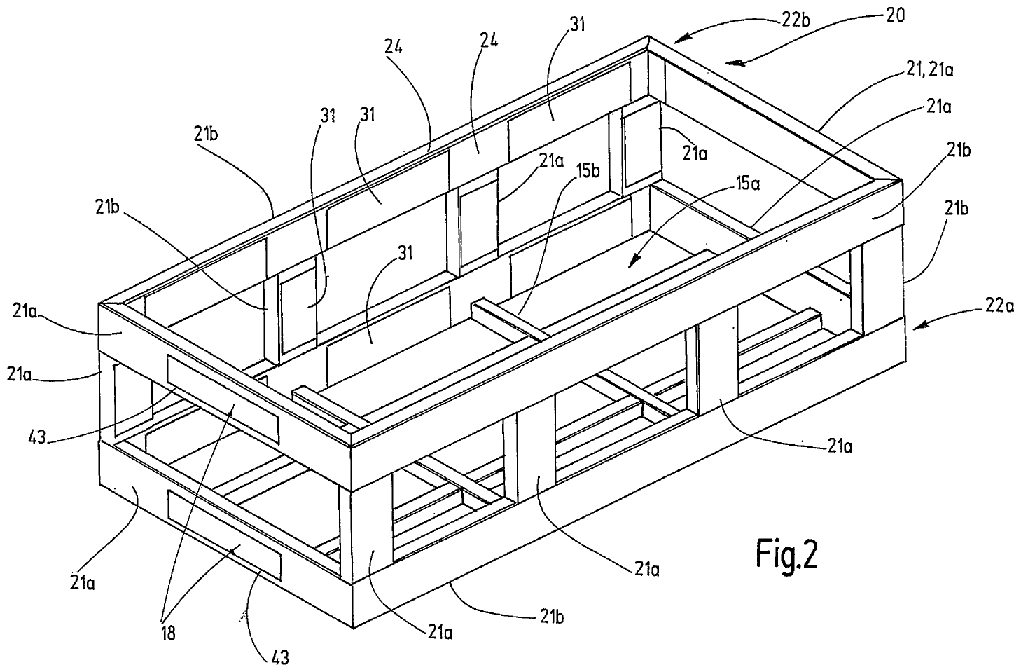

As is apparent by way of example from FIGS. 2 and 5, the housing 10 preferably comprises a skeletal frame 20, which forms a framework of the housing 10. The frame 20 is assembled from elongated support elements 21.

The frame 20 can include multiple planes 22a, b, for example a first, for example lower, plane 22a and a parallel second, for example upper, plane 22b, which are formed by planar frame sections 22a, 22b assembled from support elements 21. Intermediate planes are possible (not shown). In the illustrated exemplary embodiment, each side of the frame 20 is preferably formed by, preferably planar, frame sections, which each enclose a surface area. In other embodiments, at least one side is formed by a, for example flat, frame element. For example, the bottom of the frame can be formed by a flat frame element. As an alternative or in addition, support elements can be arranged on at least one side, for example forming a cross (not shown).

Support elements 21 can, in particular, be formed of one or more profiled sections. In the illustrated exemplary embodiment, rectangular hollow sections or square tubes are used as support elements.

The support elements can form horizontal bars 21a and vertical braces 21b, which extend parallel along the edges of the housing 10, as FIGS. 2 and 5 illustrate. In addition or as an alternative, it is also possible, in principle, to provide a frame 20 comprising diagonal support elements (struts) (not shown).

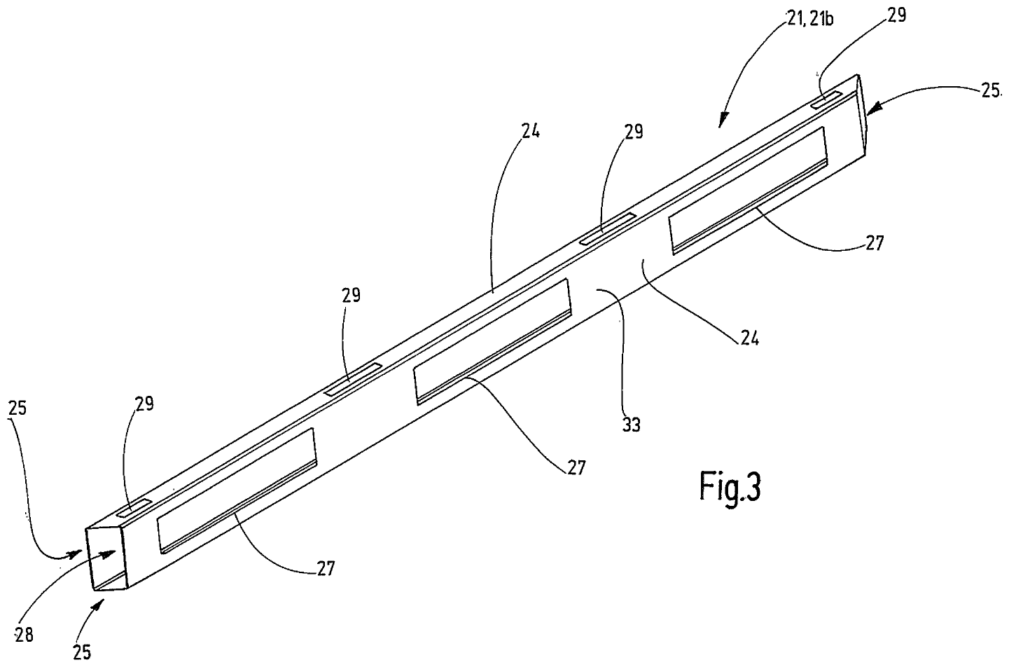

FIG. 3 shows an exemplary embodiment of a support element 21, here by way of example a support element 21 that forms a brace 21b in the illustrated exemplary embodiment according to FIGS. 1, 2 and 5, which is arranged parallel to a longitudinal side 13 of the housing 10.

The support elements 21 each comprise a tube having a rectangular or square cross-section. The illustrated support elements accordingly comprise four longitudinal sides 24 and two end faces 25 (end sides). Instead of using the rectangular tube as the base body of the support element 21, it is also possible to provide different tubes having a polygonal cross-section, for example a triangular cross-section, a pentagonal cross-section, a hexagonal cross-section, and the like. The support elements 21, which form the longitudinal sides 13 as well as the end faces 14 of the frame 20 or of the housing 10, preferably each delimit a support element interior space 26. In the support element 21a according to FIG. 3, elongated, for example rectangular, openings 27 are distributed across the length of the support element 21a. Gas can flow from the housing interior space 12 into the support element interior space 26 via these openings 27. The support element 21 moreover includes end-face connection openings 28. The end-face connection openings 28 are used to connect the support element 21 to a respective further support element 21 of the same plane 22a, 22b. The support element 21a is joined, for example bonded or welded, to abutting support elements 21b via the end-face connection openings 26 in the manner of a miter joint. The connection openings 26 can, of course, also be arranged in such a way that two support elements 21a of a plane 22a, 22b of the frame oriented transversely to one another are butt joined. In such an embodiment, which is not illustrated, a support element includes an end-face connection opening and abuts against a longitudinal side 24 of a further support element, where this has a corresponding connection opening. The end-face opening thereof, however, should be closed in a flameproof manner. Overall, a miter joint is thus preferred, since in this case a flameproof closure of the end-face opening can be dispensed with. The reason is that a flameproof connection is preferably obtained when establishing the joint between the support elements 21a across the corners. Support elements 21a for the end faces of the housing 10 or frame 20 can likewise include multiple openings, or, as shown (FIGS. 2 and 5), one opening 27 for the fluid exchange between the housing interior space 12 and the support element interior space 26.

The support element 21a shown in FIG. 3 furthermore includes longitudinal-side connection openings 29, which due to the orientation in the illustrated exemplary embodiment are upper-side or bottom-side connection openings. The longitudinal-side or upper-side or bottom-side connection openings 29 are used to connect the support element 21a to a further, vertically oriented support element 21b to establish a fluidic connection between the support element interior space 26 and the further support element 21b. In the illustrated exemplary embodiment, the end-face support elements 21a do not include any longitudinal-side connection openings for the connection to vertical support elements 21b, although this is also possible.

In the illustrated exemplary embodiment, vertically oriented support elements 21b, for connecting the two planes 22a, 22b, include end-face connection openings 28, which are arranged at the longitudinal-side connection openings 29 of the longitudinal-side support element 21a for connecting the support element interior spaces 26.

The support elements 21, which are connected in such a way that the support element interior spaces 26 thereof, in principle, are able to exchange gas, if necessary only after a rupture body, for example, has been destroyed, overall form an intermediate volume 30. Consequently, the receiving support elements 21 include those whose support element interior spaces 26 are joined to form an intermediate volume 30. The intermediate volume 30 is an unbranched flow channel, or a flow channel branched once or multiple times, which leads from the housing interior space 12 through the openings 27 in the support elements and the venting openings 17 to the outside.

The frame 20 or the housing 10 can comprise further support elements 21 which, even though they can delimit a support element interior space 26, do not form part of the intermediate volume 30 or do not have to form part of the intermediate volume 30. In the illustrated exemplary embodiment according to FIG. 2, these are arranged on the bottom side, for example.

To form the intermediate volume 30, the connecting site between the support elements 21 is preferably flameproof. The support elements 21 can be bonded and/or welded to one another, for example, wherein the adhesive and/or weld seam is preferably flameproof.

The openings 27 in the support elements 21 to the housing interior space 12 are preferably closed by pressure relief bodies 31, as is apparent from FIGS. 2, 4 and 5 by way of example. This means that at least a majority of the gas has to pass through the pressure relief body 31 when passing through the opening 27. The pressure relief bodies 31 for the openings 27 to the housing interior space 12 can be identical to or different from the pressure relief bodies 18 for the venting openings 17. The pressure relief bodies 31 can be flameproof. After passing the pressure relief body 31 and reaching the intermediate volume 30, the gas from the housing interior space 12 has cooled in such a way that it is already no longer able to ignite the atmosphere in the intermediate volume 30. The receiving support elements 21 consequently preferably comprise a flameproof shell, by way of which the receiving support element 21 delimits the support element interior space 26 transversely to the longitudinal extension direction L of the support element 21, or radially, wherein the shell can be formed by a wall 33 of the support element and/or, at least in sections, by a flameproof pressure relief body 31.

A pressure relief body 31 for an opening 27 to the housing interior space 12 and/or a pressure relief body 18 for a venting opening 17 can, for example, be composed of sintered metal spheres, metal powders, one or more woven wire cloth or laid scrim layers situated on top of one another or the like.

A pressure relief body 18, 31 preferably has open pores, the width of which is so small and the length of which is so large that flames from the housing interior space 12 cannot reach the intermediate volume 30 of the frame 20, or from the intermediate volume 30 of the frame 20 cannot reach the surrounding area. It is also not possible for any particle embers to reach the intermediate volume 30 in this way.

A pressure relief body 18, 31 can be made of metallic or non-metallic material. The particular material, such as metal, ceramic, glass, or the like, in the form of particles, spheres, threads, or foam can be shaped into a stable body by sintering, bonding or mechanical joining. Pressure relief bodies 18, 30 can in particular be designed as planar plates. The pressure relief bodies 18, 30 preferably form flame proofing filters, which have gas passage openings in the form of pores that are so narrow and so long that flames and particle embers cannot pass through.

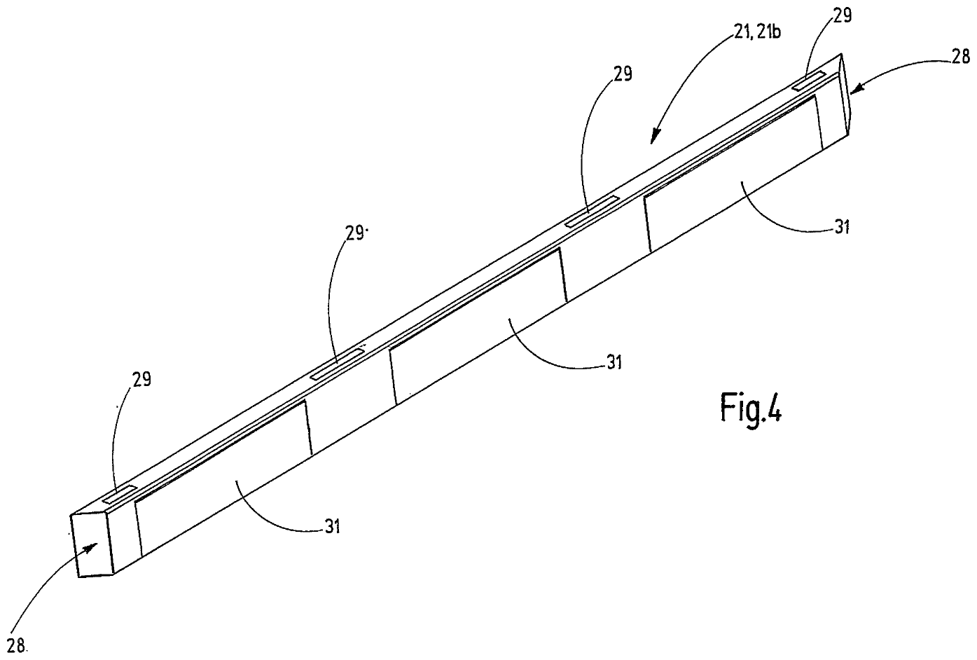

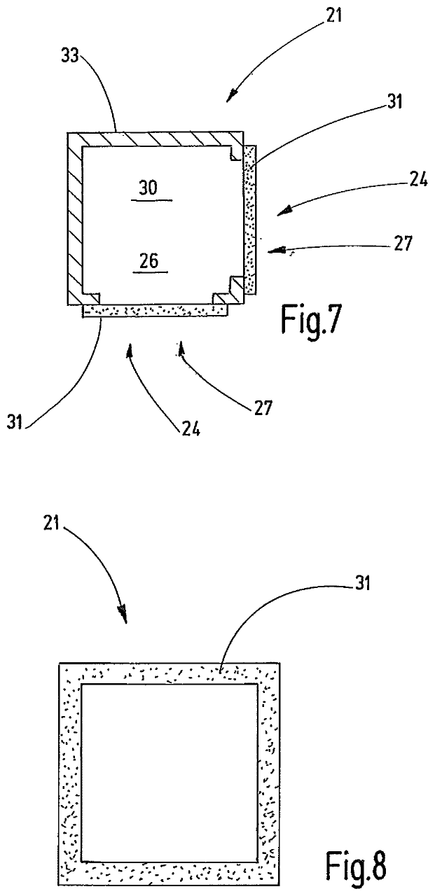

In the exemplary embodiment according to FIGS. 3 and 4, openings 27 to the housing interior space 12 are only provided on a longitudinal side 24. As the cross-sectional illustration of one exemplary embodiment of a further elongated support element 21 according to FIG. 7 of one example of a frame shows, embodiments of support elements 21 can include openings 27 for the gas exchange between the housing interior space 12 and the intermediate volume 30 or the surrounding area 11 of the housing 10, on at least two, or in particular in the case of vertical support elements 21b for example three, longitudinal sides 24 arranged at an angle with respect to one another, which abut the housing interior space 12. These openings 27 can be closed, preferably closed in a flameproof manner, by pressure relief bodies 31.

Embodiments of the frame can comprise at least one support element 21, in which a body of the support element 21 itself forms a framework-like or skeletal frame as a carrier for pressure relief bodies 31, in particular plate-shaped pressure relief bodies 31.

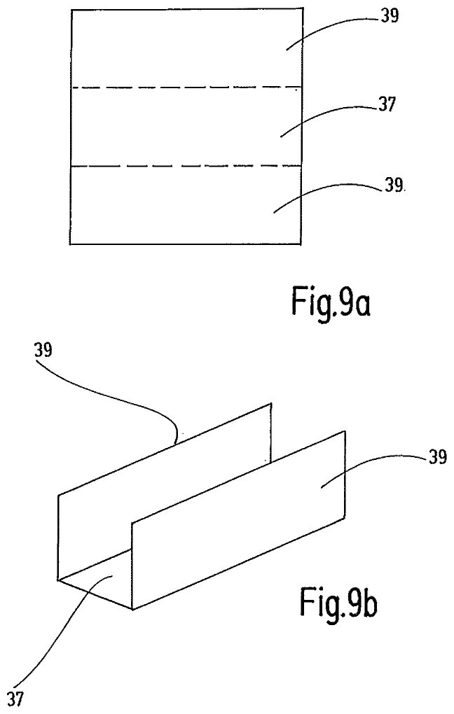

Embodiments of the frame 20 can comprise at least one support element 21, which is a profile-shaped or tubular open-pored pressure relief body 31. A corresponding exemplary embodiment is illustrated in FIG. 8 in a cross-sectional view. The pressure relief body 31 can be assembled from open-pored plates, for example, which can be welded or bonded to one another, for example.

Other exemplary embodiments of support elements (not shown) alone do not form a shell, in particular flameproof shell, if necessary with one or more pressure relief bodies. Rather, lateral openings of the support elements are only closed when connected to surface elements, so that the support elements delimit a support element interior space with the surface elements.

Support elements 21 may be present that, even though these, with the support element interior space 26 thereof, contribute to the intermediate volume 30, do not have any direct openings 27 to the housing interior space 12. These are arranged, for example, in the lower plane 22a at the end faces 14 in the exemplary embodiment according to FIG. 2. However, similarly to the end-face support elements 21 arranged in the upper plane 22b of the exemplary embodiment, these can include recesses 36 to establish venting openings 17 of the housing 10.

The frame 20 forms a framework for the housing 10. Surface elements 37 to 40 can form the outer planking of the frame. The surface elements 37 to 40 for the longitudinal sides 13, end faces 14, bottoms 15, and covers 16 can be fastened to the frame 20. In principle, exemplary embodiments in which the surface elements 37 to 40 are arranged in the frame 20 and fastened to the frame 20 are also possible. The frame then forms an outer skeleton (not shown).

The housing according to FIG. 1 is closed by plate-shaped surface elements 37 to 40, which can be fastened to the frame 20. FIGS. 1 and 5 show the exemplary frame 20 according to FIG. 2 including planking made of plates 37, 38, which close the housing on the longitudinal side and on the end face. A further plate 39 closes the housing 10 on the bottom side. In particular the plates 37, 38 that close the housing on the longitudinal side and on the end face can be fastened to the frame 20. The plates 37, 38 can, in particular, be connected to the support elements 21 in a punctiform or linear manner, for example by means of punctiform or linear weld seams or spots 41. In the illustrated exemplary embodiment, the plates 37, 38 for the longitudinal sides 13 and end faces 14 according to FIGS. 1 and 5 are connected to the support elements 21 by means of spot welding joints 41.

Plates, in particular the plates 37 to 39 for the longitudinal sides 13 and end faces 14 and the bottom 15, can be joined among one another, for example welded and/or bonded to one another. The plates 37 to 39 can be joined to one another, for example, so that a flameproof gap or a sealing seam 42 is formed between the plates 37 to 39 to limit an explosion to the interior space of the housing. The plates 37 to 39 do not necessarily have to establish a flameproof gap with the frame or with the support elements 21, but can do so in embodiments, wherein then, if necessary, explosion-proof sealing seams 41 can be dispensed with.

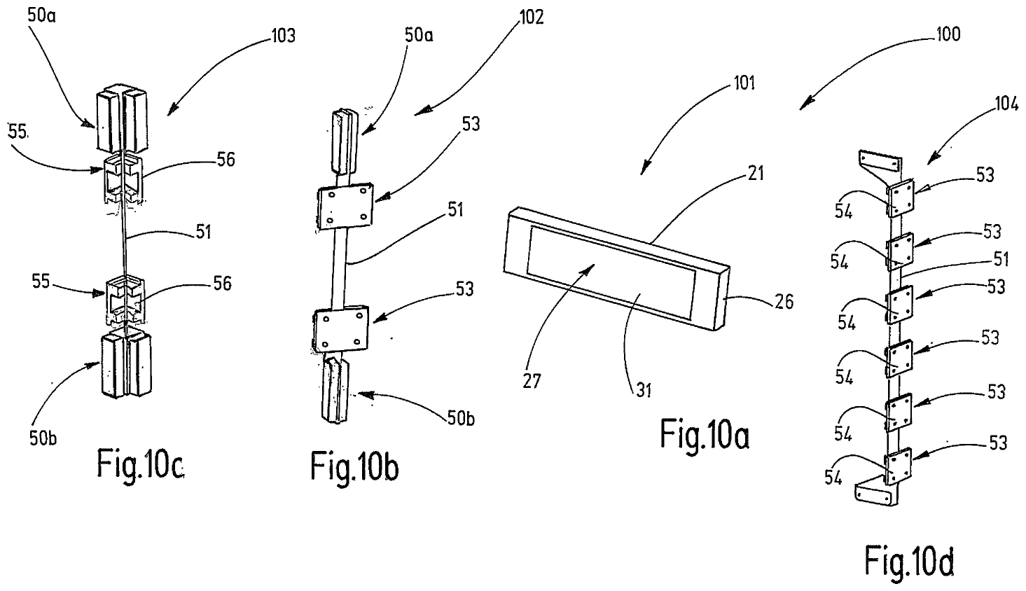

Mutually abutting plates 37 to 39 can be seamlessly joined to one another in one piece. One option for producing the housing 10 is shown in FIGS. 9a, 9b by way of example. There, a sheet metal-like basic material is bent along the dotted lines to form three abutting plates 37, 39, and thus a portion of the shell of the housing 10. The formation of elongated weld seams, which have to be tight, is dispensed with along the dotted line. In exemplary embodiments, a sheet metal material may, of course, also only be bent along a line to form surface elements for closing sides of the housing 10 designed transversely to one another.

The frame 20 and the surface elements 37 to 40, preferably at least the surface elements 37, 38 for the end faces 14 and the longitudinal sides 13 of the housing 10, are preferably made of the same material. For example, both the frame 30 and the surface elements 37 to 40 can be made of aluminum, steel, or plastic, or composite material. When the frame 30 and the surface elements 37 to 40 are made of the same material, the thermal coefficients of expansion are comparable, which avoids stresses.

To establish at least one venting opening 17, one or more surface elements 37 to 40 can include at least one recess 43.

The pressure relief bodies, by means of which the venting openings 17 can be closed, can, as shown, be arranged in the support element interior space 26. As an alternative, the pressure relief body 18 can be fastened to the outside of the surface element 38 to close the venting opening 17 in a flameproof manner.

Electrical feedthroughs for contacting the components in the interior space 12 of the housing 10, or mechanical feedthroughs for transferring a movement, can be arranged in one or more of the surface elements 37 to 40. These feedthroughs (not shown) are flameproof to prevent an explosion in the interior space of the housing from rolling over into the surrounding area at a location of the surface element 37-40 at which a feedthrough is arranged.

It is possible to render the connection between the housing interior space 12 and the surrounding area 11 of the housing 10 through the intermediate volume 30 flameproof by closing, in a flameproof manner, the openings 27 in the support elements 21 for connecting the support element interior spaces 26 to the housing interior space 12. As an alternative or in addition, the at least one venting opening 17, which establishes a connection between the intermediate volume 30 and the surrounding area 11 of the housing 10, can be closed in a flameproof manner.

In the illustrated exemplary embodiment, both the openings 27 in the support elements 21 are closed in a flameproof manner, and the venting openings 17 are closed in a flameproof manner. When gas in the intermediate volume 30 is ignited, for example since walls of the support elements 21 reach the ignition temperature, the gas is able to exit the venting opening 17, if need be, in such a cooled state, as a result of the flameproof closure of the venting opening 17, that it cannot ignite the atmosphere outside the housing 10. If the flameproof closure of the venting opening 17 is dispensed with, care must be taken to ensure, for example, that gas in the intermediate volume 30 cannot be ignited.

As an alternative or in addition to forming a flameproof shell of the support elements 21 by way of the flameproof pressure relief bodies 31, which delimits the support element interior space 26 transversely to the longitudinal extension direction L of the support element 21, the connection between the housing interior space 12 and the intermediate volume 30 may not be flameproof. Only the one or more venting openings 17 are closed in a flameproof manner.

In still other embodiments, no venting openings 17 are present. The interior space openings 27 in the receiving support elements 21 can then be partially closed by pressure relief bodies 31, which can be flameproof, but in embodiments do not have to be flameproof. By closing the interior space opening 27 at least partially, or across the entire surface area, with a pressure relief body 31, it is ensured that the gas cools as it passes through the interior space opening 27 and enters the intermediate volume 30, wherein heat absorption by the pressure relief body 31 and, if necessary, expansion upon the entry from the pressure relief body 18 into the intermediate volume 30 can contribute to cooling. For example, the Joule-Thomson effect may come into play.

The intermediate volume 30 or the channel and/or each support element interior space 26 preferably has a greater surface-to-volume ratio than the interior space 12 of the housing 10, so that penetrating gases from the interior space 12 are cooled better than in the interior space 12 of the housing 10.

For a flameproof closure of the venting opening 17, as illustrated in FIG. 5, the end-face plate 38, due to the pressure relief body 18 arranged in the support element 21 in the illustrated exemplary embodiment, has to be connected around the venting opening 17 to the end-face support elements 21a, 21b in such a way that gases, which are so hot that they can ignite the atmosphere outside the housing 10, are prevented from exiting. This is possible, for example, by forming a flameproof gap between the plate 38 and the support element 21a, 21b or by way of a sealing seam joining the plate 38 to the end-face support elements 21a, 21b.

Possible exit paths from the housing interior space 12 into the surrounding area 11 are preferably limited to those that lead through the intermediate volume 30. In particular the surface elements 37, 38, 39, 40 are preferably free of such openings that establish a gas connection between the interior space 12 of the housing 10 and the surrounding area 11, without the gas having to take a path through an intermediate volume 30 formed by the receiving support elements 21 of the frame 20.

The advantage of interposing an intermediate volume between the interior space 12 of the housing 10 and the surrounding area 11 is that the gas, in the event of an explosion, is able to enter the intermediate volume 30 in a plurality of locations inside the housing interior space 12, and the actual connection to the surrounding area 11 can be arranged in a central location. In embodiments, only the closure of the venting opening 17 or of the venting openings 17 has to be flameproof and must not exceed a maximum surface temperature, to avoid that atmosphere at the closure ignites. Moreover, the intermediate volume 30 forms an absorption chamber for a pressure wave coming from the interior space 12 of the housing 10. A portion of the kinetic energy and thermal energy released by the explosion can be taken up by the plurality of pressure relief bodies when the gas passes through the pressure relief bodies into the intermediate volume 30.

As is apparent by way of example from FIG. 5, the housing 10 can comprise a frame-shaped flange 45 for fastening the cover 16. The flange 45 is preferably welded and/or bonded to the longitudinal-side plates 37 and the end-face plates 38, so that the weld seam and/or bonded seam is flameproof. As an alternative or in addition to the formation of a sealing seam between the flange 45 on the one hand, and the longitudinal-side and end-face surface elements 37, 38 on the other hand, a flameproof gap can be established between the flange 45 on the one hand, and the longitudinal-side and end-face plates 37, 38 on the other hand.

The establishment of flameproof gaps between the support elements 21 and the surface elements 37, 38 can be dispensed with. Otherwise, it could be sufficient to also establish a flameproof gap, in particular a flat gap between the flange 45 and the support elements 21 of the upper plane 22b, so as to design the housing to be flameproof at this location.

The flange 45 can include threaded holes 46 or other devices to connect the cover 16 to the flange 45. The threaded holes 46 can form flameproof gaps with the fastening pins for fastening the cover 16. A flameproof gap, in particular a flat gap, can be established between the flange 45 and the cover 16.

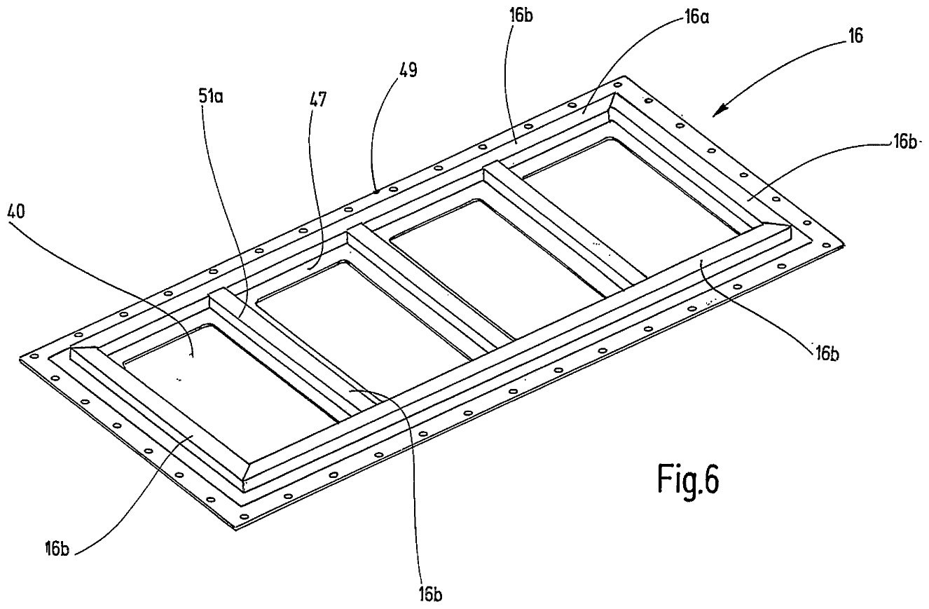

A cover 16, as it can be used for the exemplary housing 10 according to the invention, is apparent by way of example from FIG. 6. The cover 16 comprises a plate-shaped surface element 40. The cover 16 can comprise a stabilizing intermediate plate 47, which can include recesses. The cover 46, however, can also make do without the intermediate plate 47. The cover plate 40 comprises an edge region 49 in which openings for fastening pins are arranged, which cooperate with the threaded holes 46 of the flange. The edge region 49 is configured to form a flameproof gap, in particular a flat gap, with the flange 45.

A bracing frame 16a can be arranged on the inner side of the cover 16. The bracing frame elements 16b of the bracing frame, however, do not contribute to the intermediate volume 30. The same applies to the bracing frame elements 15b of the bracing frame 15a of the bottom 15 in the illustrated exemplary embodiment. In other embodiments, the bracing frame elements 15b of the bottom 15 can likewise be support elements 21 of the frame 20 and form part of the intermediate volume 30. This means that the support element interior spaces 26 of the bracing frame elements 15b are fluidically connected to the end-face and longitudinal-side support elements 21 of the lower plane 22a.

During use, the cover 16 is fixedly connected to the remaining housing body shown in FIG. 5, wherein corresponding connecting means, such as clamps, screws (as in the illustrated exemplary embodiment) or the like are used for this purpose. Components that can form ignition sources, such as relays, transistors, resistors or similar elements that can heat up during operation, are present in the housing interior space 12. When the housing 10 is located in an explosive atmosphere, combustible or explosive gases can reach the housing interior space 12. If they are ignited there, the deflagration that occurs results in an expansion of the involved gases. The intermediate volume, formed by the support element interior spaces, is preferably free of electrical or electronic components, which can form ignition sources. If components are arranged at all in the intermediate volume, these are preferably designed to be intrinsically safe.

These flow, while cooling, through the openings 27 in the support elements 21 into the intermediate volume 30, and from there via the venting openings 17 to the outside. As a result of the explosion, possibly present rupture disks can be destroyed. In any case, at the latest then the fluidic connection between the housing interior space 12 and the support element interior space 26 is open. Gas can now flow from the housing interior space 12 into the support element interior space 26.

The gas cools upon entering the support element interior spaces 26. When the openings 27 into the support element interior spaces 26 are closed by open-pored pressure relief bodies 31, this results in even more cooling, in particular due to heat transfer to the pressure relief body 31. In embodiments of the housing 10, the pressure relief bodies 31 closing (covering) the openings 27 may not be flameproof themselves, but can still result in a certain degree of cooling of the gas, for example due to the absorption of thermal energy, when the gas passes through the openings 27 into the intermediate volume 30.

When the pressure relief body 31 closes the opening 27 in a flameproof manner, the gases or particles, as they pass through the pressure relief body 31, are cooled to such an extent that the gases making their way into the intermediate volume 30, which is a channel, if necessary a channel branched multiple times, no longer represent an ignition source for explosive gas in the intermediate volume 30 or in the surrounding area 11 of the housing 10.

When the pressure relief body 18 closes the venting opening 17 in a flameproof, the gases, as they pass through the pressure relief body 18, are cooled to such an extent that the gases or particles making their way from the intermediate volume 30 or the housing interior space 12 through the venting opening 17 no longer represent an ignition source for explosive gas in the surrounding area of the housing.

The excess pressure as a result of the explosion is consequently reduced by the gas, during an explosion, being able to enter from the interior space 12 of the housing through the one or more openings 27 in the support elements 21 into the intermediate volume 30, whereby it can already experience initial cooling. The pressure wave can consequently be partially absorbed by the intermediate volume. Excess pressure in the intermediate volume 30 is reduced via the venting openings 17, if any are present.

If the openings 31 in the support elements 21 are not closed in a flameproof manner, or if the gas in the intermediate volume 30 is at risk of exploding for another reason, for example because the inner surface of the support elements 21 can potentially become so hot that gas ignites therein, the at least one venting opening 17 is preferably closed in a flameproof manner.

Preferably, at least a portion of the cross-section of the channel 30 formed by the support element interior spaces 26 connected among one another is free of porous material to provide minor resistance to the gas inside the channel 30. In the event of an explosion, for example in a corner of the large-volume housing 10, it is thus possible for gas that, for example, has not ignited, to be pushed, for example from an opposite corner, with overall minor resistance through the openings 27 from the interior space 12 of the housing 10, the channel 30, and out of the venting openings 17.

Modular systems according to the invention are suitable for producing in particular large housings 10 having a housing interior space 12 with a volume of greater than or equal to 100 liters, greater than or equal to 500 liters, or even greater than or equal to 1000 liters, although modular systems according to the invention can also be used for smaller volumes.

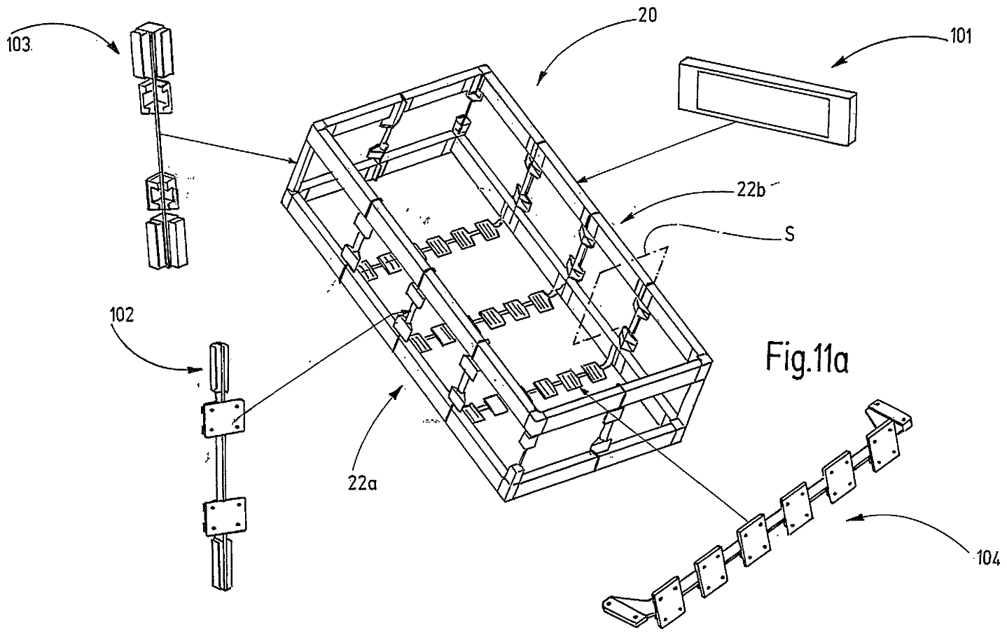

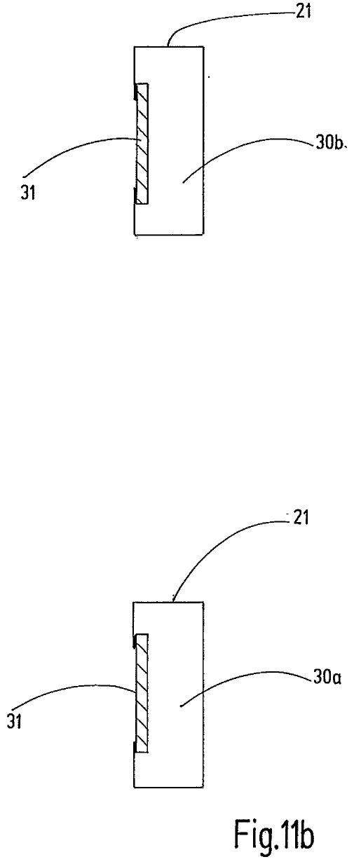

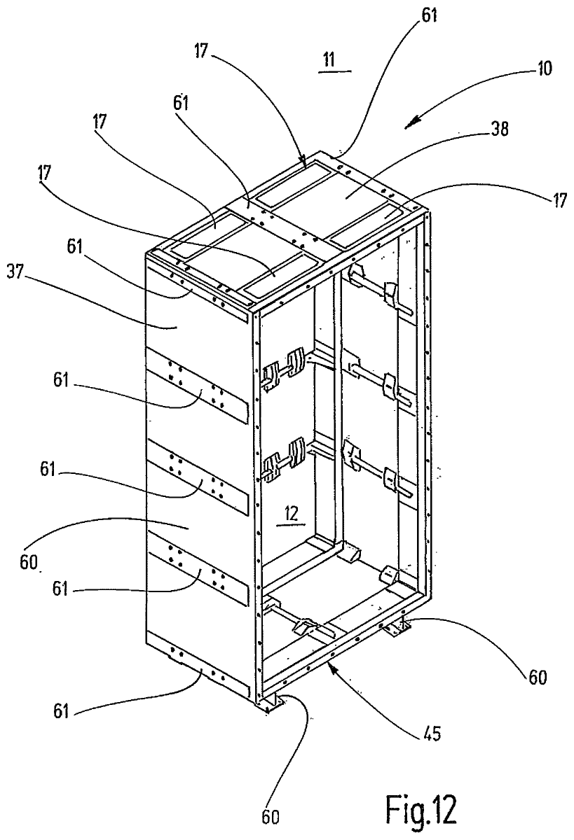

FIG. 10 shows modules of an exemplary embodiment of a modular system 100 according to the invention for producing frames 20 of varying sizes. FIG. 11a shows an example of a frame 20, composed of the modules of the modular system 100, and FIG. 12 shows an example of a housing 10 composed by means of the frame 20 according to FIG. 11a. Potential differences compared to the exemplary embodiments according to FIGS. 1 to 9, in addition to the essential difference that FIGS. 10 to 12 relate to a modular system 100 or a frame 20 and a housing 10 composed thereof or therewith, can be derived from the following description. Otherwise, the description regarding the exemplary embodiments according to FIGS. 1 to 9 can be used for the description of details of possible exemplary embodiments of the modular system 100 or a frame 20 and a housing 10 composed thereof.

A first module 101 of the modular system 100 is a receiving support element 21, which delimits a support element interior space 26 and an opening. In specimens of the first module 101, this opening can serve as the interior space opening 27 of the fluidic connection of the housing interior space 12 to the support element interior space 26. The opening is preferably closed by a pressure relief element 31 in a flameproof manner.

A second module 102 of the modular system 100 is used to connect two adjoining receiving support elements 21, which are arranged behind one another in a longitudinal direction, in one plane.

A third module 103 of the modular system 100 is used to connect two adjoining receiving support elements 21, which are arranged across the corners, in one plane. The second module 102 and the third module 103 likewise form support elements 21 of the frame 20. The second module 102 and the third module 103 can comprise first connecting channel sections 50a to connect the support element interior spaces 26 of adjoining support elements 21 of a plane to one another. The connection between adjoining support element interior spaces 26 is preferably flameproof with respect to the interior space 12 of the housing 10, so that an explosion in the intermediate volume 30 cannot roll over into the interior space 12 of the housing 10. The connected receiving support elements 21 of a plane form a planar, two-dimensional first frame section 22a. Using the same second and third modules 102, 103, further receiving support elements 21 can be connected in a flameproof manner via second connecting channel sections 50 in a further parallel plane to a planar, two-dimensional second frame section 22b. The second and third modules 102, 103 comprise connecting webs 51. In a second or third module 102, 103, a connecting web 51 rigidly connects the first connecting channel section 50a to the second connecting channel section 50b. The frame sections 22a, 22b are connected via the connecting webs 51 of the second and third modules 102, 103 to form a three-dimensional, skeletal frame 20. The second and third modules 102, 103 can be joined by welding and/or bonding, for example, to the abutting receiving support elements 21 of the first module type 101.

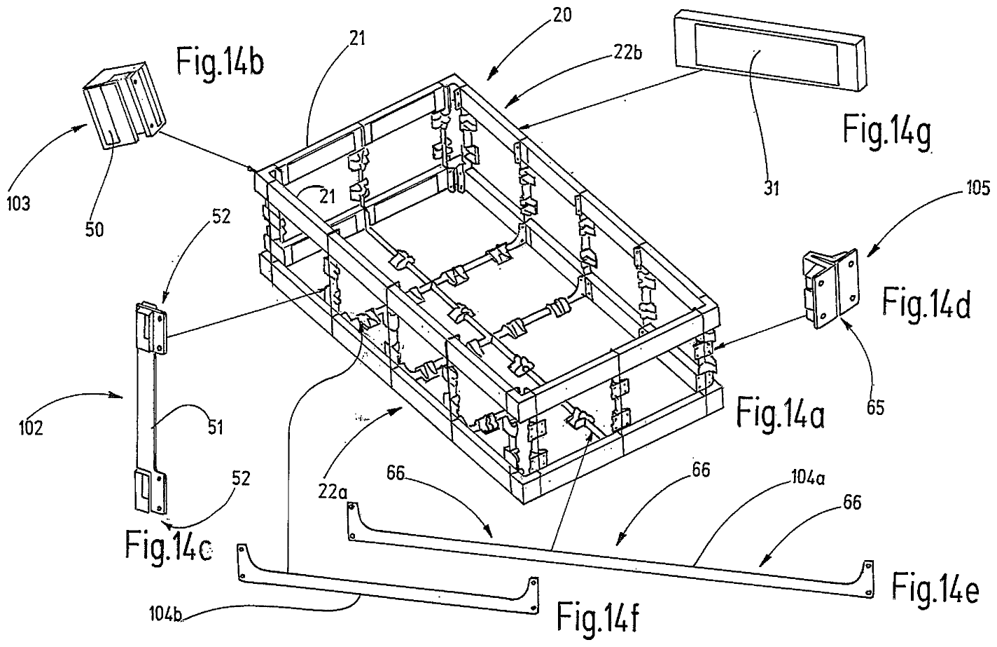

An elongated, web-like fourth module 104 of the modular system 100 is configured to connect opposing support elements of the second module type 102 inside the first frame section 22a, so that a basket-shaped three-dimensional frame 20 is obtained, as it is illustrated in FIG. 11a. The fourth module 104 and the opposite second modules 102 can each be connected by way of a screw joint, for example. The corresponding section of the second module for the screw joint is hidden in FIG. 10b. A corresponding section for establishing the screw joint 52 is illustrated in FIG. 14c based on another exemplary embodiment of a module of the modular system.

The planar first frame section 22a and the planar second frame section 22b of the basket-like frame 20 according to FIG. 11a assembled from the modules 101, 102, 103, 104 of the modular system 100 each have a contiguous intermediate volume 30a, 30b, formed of the support element interior spaces 26 of the receiving support elements 21 and the interior spaces of the connecting channel sections 50a, 50b. FIG. 11b shows a sectional view through the cutting plane S in FIG. 11a for illustration. The intermediate volumes 30a, 30b are not directly connected among one another, so that gas flowing from an intermediate space 30a to the other intermediate space 30b would have to take the detour through the interior space 26 of the housing 10.

The modular system 100 allows basket-like frames 20 having different lengths to be produced from the four basic types 101, 102, 103, 104 of modules, as illustrated in FIGS. 10a-10d.

The second module 101, the third module 103, and the fourth module 104 can be provided in adapted lengths, and, if necessary, adapted in terms of the number of connecting sections 53 for the connection to surface elements 37 to 39, to be able to produce frames 20 having different widths and/or different depths. It is preferably provided for the modular system 100 that the length of the first module 101 is not varied, but the module forms a common part, which is arranged in various quantities in a width direction and/or in a length direction to produce frames 20 having different widths and/or lengths.

The surface elements 37 to 40 can be connected to the frame 20 for closing the housing 10 by way of flat connecting sections 53. The second module 102 and/or the fourth module 104 can, for example, comprise connecting sections 53, as is illustrated in the exemplary embodiment according to FIGS. 10b to 10d. The connecting sections 53 of the second module 102 of and of the fourth module 104 preferably each provide a planar, patch-like, for example rectangular, in particular square, connecting surface 54 so as to form patch-like connecting regions with the surface elements 37, 39. The third module 103 comprises angled connecting sections 55. As an alternative or in addition, connecting sections 53, 55 of the second, third and/or fourth modules 102, 103, 104 can be separate modules of the modular system 100. A corresponding exemplary embodiment is shown in FIGS. 14c and 14d. In such embodiments, the connecting web 51 of the second, third or fourth module 102, 103, 104 is arranged between the separate module, which provides the connecting surface 54, 56, and the surface element 37, 38, 39, when the connection has been established.

The connecting sections 53, 55 are accessible from the interior space 12 of the housing 10 or the frame 20, so that a screw joint can be established with the surface elements 37 to 39 from the interior space 12. As an alternative or in addition to a screw joint, connecting surfaces 54, 56 of the connecting sections 53, 55 can be bonded and/or welded to the surface element 37, 38, 39. A pure screw joint is preferred over a pure weld and/or bonded joint due to the potentially higher strength.

The connecting surfaces 54, 56, which are separate from one another, are planar in a patch-like manner, for example square, as in the illustrated exemplary embodiment, or angled. Compared to a variant including connecting surfaces that are contiguous, in the form of a strip, in the longitudinal extension of the second, third or fourth module 102, 103, 104, this has the advantage that rough tolerances of the surface element 37, 38, 39 and/or of the module 102, 103, 104 can be more easily compensated for.

Even if a screw joint having bores that perforate the surface element 37, 38, 39 is provided between the connecting sections 53, 55 and the surface element 37, 38, 39, the flameproof nature of the housing 10 nonetheless must be ensured. This can take place, as in the illustrated exemplary embodiment, by ensuring a sufficiently long thread gap between the external thread and internal thread in the bore.

The surface elements preferably comprise a base material 60 made of sheet metal having a constant thin wall thickness for this purpose, having dimensions that completely close the side of the housing 10. Strip-shaped (as illustrated), or alternatively patch-shaped, reinforcement metal sections 61 are fastened to the outside of the metal sheet 60, for example bonded and/or welded to the base material 60. The thickness of the reinforcement metal metal section 61 alone, or together with the thickness of the base material 60, is sufficiently dimensioned to provide a flameproof thread gap to ensure the flameproof nature. Attaching the reinforcement metal section 61 to the outside has the advantage that, in the event of an explosion in the interior space 12 of the housing 10, the base material 60 is pushed against the reinforcement metal sections 61. As a result, the strength of the connection between the reinforcement metal section 61 and the base material 60 is less important than if the reinforcement metal section 61 were arranged on the inside of the base material 60 in the interior space 12.

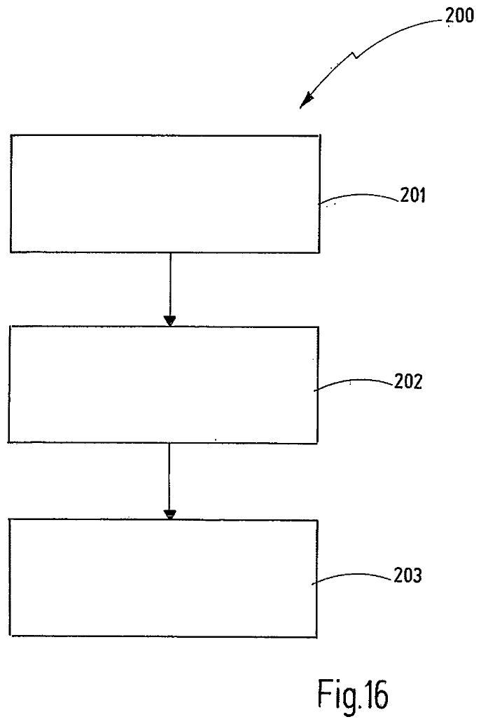

A frame 20 according to the invention can be produced as follows, for example by means of the modular system 100 from FIGS. 10a to 10d, wherein this is schematically represented in the flow chart of an exemplary embodiment of the method 200 according to the invention according to FIG. 16: Elements 101, 102, 103, 104, 21 can be fixed to one another (step 201) in such a way that an alignment of the frame 20, or of a sub-structure of the frame 20, is still possible. The frame 20 or the sub-structure can be aligned (step 202), and the alignment can be fixed (step 203). The fixing 201 of elements and alignment 202 can take place incrementally by first creating sub-structures of the frame by fixing the elements 201, aligning the sub-structure, and fixing the alignment, and thereafter adding further elements, aligning the resulting sub-structure, and fixing the alignment. As an alternative, initially all elements can be fixed so as to form the frame. The frame is then aligned, and the alignment is fixed thereafter. In both instances, the alignment can compensate for relatively rough tolerances of the components of the frame 20. After the frame sub-structures or the frame 20 has or have been aligned, the elements can be rigidly fixed to one another so as to fix the alignment of the frame sub-structure or of the frame 20, and to ultimately complete the support frame 20.

Thereafter, the surface elements 37, 38, 39 can be fastened to the connecting sections 53, 55. The surface elements 37, 38, 39 are sealingly welded and/or bonded to one another along the edges of the housing 10. A flange 45, which is used to connect the surface elements 37, 38 to the cover 40, is welded and/or bonded to the surface elements 37, 38. Similarly to the exemplary embodiment according to FIG. 5, the flange 45 can, for example, be produced from elongated profiled sections, for example rectangular sections. A flat gap is preferably formed between the flange 45 and the cover 40 so as to ensure the flameproof nature at this location.

It shall be noted that, when a cover 16 is mentioned in the present application, this does not necessarily mean that the housing 10 is to be inserted in an orientation in which the cover 16 closes an opening toward the top.

FIG. 12, for example, shows a housing 10 that comprises a frame 20 including modules 101, 102, 103, 104 from the modular system 100 according to FIGS. 10a to 10d and planking made of the surface elements 37 to 39. Feet 60 are arranged at a surface element 38, on which the housing 10 can sit. The cover 16 of the exemplary embodiment according to FIG. 5 can be used for closing the housing, as is described in connection with FIG. 6.

Venting openings 17 are provided in the upper side of the housing 10 according to FIG. 12 to connect the first intermediate volume 30a and the second intermediate volume 30b to the surrounding area 11 of the housing 10. The venting openings 17 can be closed by rupture disks. The modular system 100 can comprise a fifth module (not shown) in addition to the modules according to FIG. 11a, which is a receiving support element 21 including an opening for forming a venting opening 17. As an alternative or in addition, specimens of the first module 101 having an appropriate orientation of the opening 27 can form a receiving support element 21 including a venting opening. As an alternative or in addition, it may be provided, when using the modular system 100, that venting openings have to be created, for example cut-out or exposed, in specimens of the first module 101.

Embodiments of modular systems according to the invention comprise modules 101, 102, 103, 104 made of the materials steel, aluminum or plastic and can be used to produce a support frame 20 for planking made of steel, aluminum, or plastic plates.

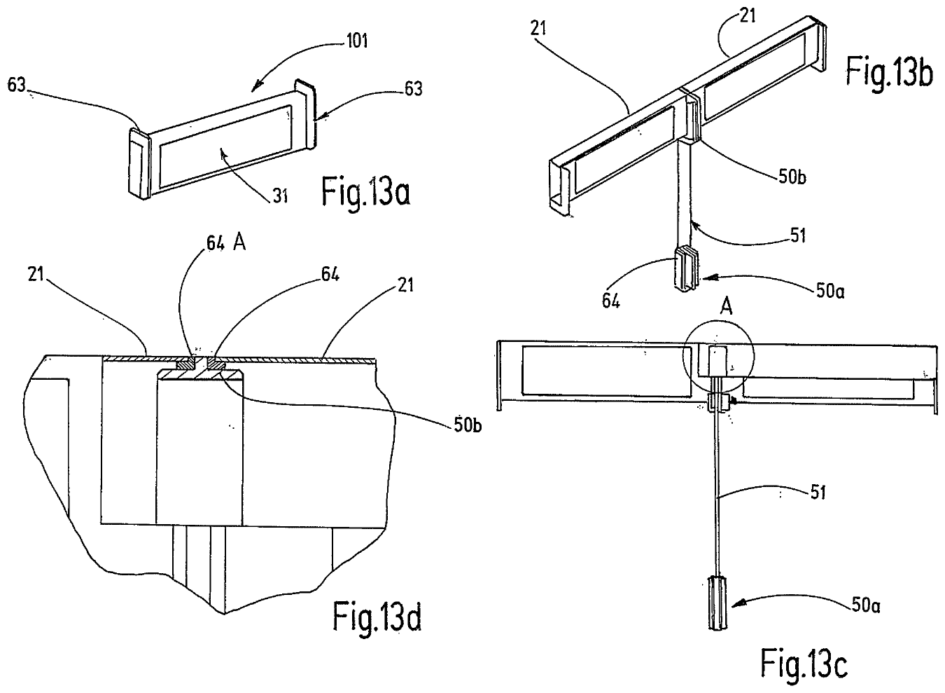

FIGS. 13a to 13d illustrate a variant of the embodiment of the modular system 100 according to FIGS. 10a to 12. The first module 101, similarly to the first module according to FIG. 10a, comprises a hollow section as the base body and, in contrast to the exemplary embodiment according to FIG. 10a, comprises welded-on and/or bonded-on flange sections 63, which are configured for creating a screw joint of two adjoining receiving support elements 21 by means of openings. The advantage of the embodiment according to FIGS. 13a-13d is that the weld joint for fastening the flange sections 63 can be created without the receiving support elements 21 already having been assembled to form a frame 20. The receiving support elements 21 can be pushed toward one another by means of the screw joint after the assembled receiving support elements 21 have been assembled and aligned, wherein a second module 102, which essentially corresponds to the embodiment described in connection with FIG. 10b, is clamped between adjoining receiving support elements 21. In the process, sections of the first module 101, of the second module 102, or additional elements that can be referred to as sealing sections 64 or sealing elements 64, are deformed so as to close gaps present between adjoining receiving support elements 21 at least in such a way that gas and/or particles can leave the intermediate volume through the gap in a non-ignitable state, at the most. Independently thereof, the second module 102 can be a casting. Designing the second module 102 (see also the exemplary embodiment according to FIG. 14c) exclusively with openings oriented in a single direction makes this possible, using a simple tool.

FIG. 14a shows a perspective view of a frame 20 according to the invention, produced with the aid of a modification of the modular system 100 according to FIGS. 10a to 12. Modules 101 to 104b are shown in FIGS. 14b to 14f. Corner modules 103 comprising a connecting web 51, as shown in FIG. 10c, are not present in this modular system 100. Instead, angular modules 103 (see FIG. 14b), which comprise a connecting channel section 50, in a planar frame section 22a or 22b connect adjoining receiving support elements 21, of which the frame 20 is composed, across the corners, without connecting the planar first frame section 22a and the planar second frame section 22b to one another. The second module 102 according to FIG. 14c differs from the second module 102 shown in FIG. 10b in that a connecting section 53 is absent in the second module 102 according to FIG. 14c. As illustrated in FIG. 14d, this is formed by a module 105 that is separate from the second and fourth modules 102, 104a, 104b (FIGS. 14c, 14e, and 14f) and that includes a slotted receiving section 65 in which the second or the fourth module 102, 104a, 104b is accommodated.

The fourth module 104 can be present in at least two variants 104a, 104b, which connect specimens of second modules 102 located opposite one another in the longitudinal direction of the frame or in the transverse direction of the frame 20. One variant 104a of the fourth module can be configured by means of form-fit sections 66 (such as notches) to establish certain positions for the specimens of the variant 104b of the fourth module oriented in the transverse direction along the length of the specimen of the fourth module 104a, which is oriented in the longitudinal direction.

Otherwise, the description regarding the embodiment according to FIGS. 1 to 12 with respect to the description of details of a frame 20, composed as is apparent from FIGS. 14a to 14g, can be used. In particular, the first module 101, that is, the receiving support element 21, can be designed as described in connection with the embodiment according to FIGS. 10a to 12. The modification according to FIGS. 13a to 13d can also be used in an exemplary embodiment corresponding to FIGS. 14a to 14g.

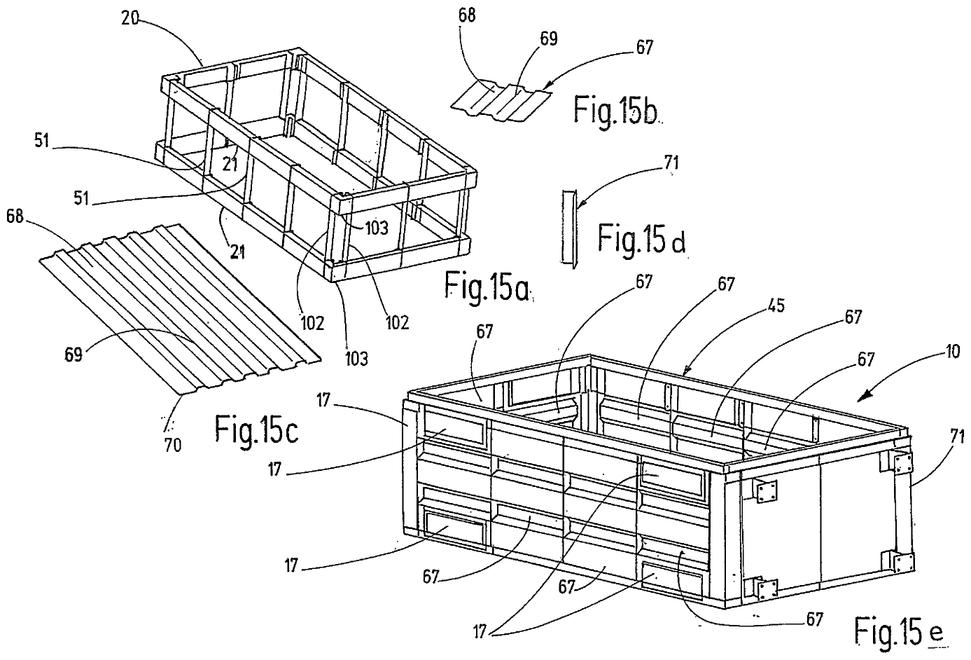

FIGS. 15a to 15e illustrate an example of a modification of the frame 20 according to FIGS. 14a to 14g, and an explosion-proof housing 10 of the ‘flameproof enclosure’ protection type formed therewith. The embodiment of the modular system 100 of which the frame 20 according to FIG. 15a is composed does not require the fourth module 104, 140a, 104b for connecting opposing second modules 102 and does not require connecting sections 53, 55 for the screw joint to the surface element 37, 38, 39. The cells or openings formed by two adjoining connecting webs 51 and interposed receiving support elements 21 are intended to be closed by sheet metal elements 67 (see FIG. 15b), in which the sheet metal is shaped to alternately form recessed beads 68 and raised beads 69. The longitudinal extension direction of the recessed and raised beads 68, 69 is preferably oriented parallel to the longitudinal extension direction of the receiving support elements 21 or transversely to the longitudinal extension direction of the connecting webs 51. The sheet metal elements 67 are preferably trapezoidal sheet metal elements, which, in sections, makes straight weld seams and/or bonded seams possible between the trapezoidal sheet metal and abutting connecting webs 51 of the specimens of the modules 102. Each sheet metal element 67 is arranged in the cell or opening to which the sheet metal element 67 is assigned. The sheet metal element 67 is connected to the adjoining second modules 102, which are illustrated by way of example in FIG. 14c, and the parallel receiving support elements 21, for example by means of a weld and/or bonded joint.

Similarly to the housing 10 according to FIG. 12, for example, the housing 10 can include venting openings 17 on the upper side and/or, as illustrated in FIG. 15e, lateral venting openings 17. These are formed by corresponding recesses in lateral receiving support elements 21 and the sheet metal element 67 that closes the cell, which delimit the receiving support elements 21.

Even though the second modules 102 in the frame according to FIG. 15a, similarly to what is shown by way of example in FIG. 14c, can comprise devices 52 for creating a screw joint with the fourth modules 104, these are preferably not required to stabilize the surface element 39 forming the rear wall. The surface element 39 is preferably not a planar sheet metal element, but a sheet metal element 70 comprising integrally formed recessed beads 68 and raised beads 69, for example a trapezoidal sheet metal element (see FIG. 15c). The longitudinal extension direction of the recessed beads 68 and of the raised beads 69 is parallel to the longitudinal extension direction of the first frame section 22a. The surface element 39 is preferably welded and/or bonded to the elements, in particular receiving support elements 21, that form the first frame section 22a, so as to close the opening established by the first frame section 22a in a flameproof manner.

The edge openings are closed by means of metal corner plates 71 (see FIG. 15d) forming an edge, which are welded and/or bonded to the corner modules 103 as well as the second modules 104.

FIGS. 15a to 15e illustrate a modular system for producing a frame 20 or housing that, in embodiments, provides that lateral surface elements 37 are composed of individual, identical sheet metal elements 67, 71.

A weld joint and/or bonded joint between elements can form a sealing seam, which closes all the gaps between the elements to be connected, so as to be able to dispense with a flameproof gap, in particular a flat gap, in this location when no ignitable gas or particles is ore are supposed to exit in this location. Sealing seams can, for example, be provided at the butt joints between support elements 21 when the interior space 12 of the housing 10 is to be separated in a flameproof manner from the intermediate volume 30, 30a, 30b, that is, when the interior space openings 27 in the support elements 21 are closed by gas-permeable, but flameproof pressure relief bodies 31.

While the figures show exemplary embodiments of frames 20 and housings 10 that are cuboidal, embodiments of frames 20 or housings 10 according to the invention can delimit interior spaces 12 across at least one corner. For example, a housing 10 according to the invention can enclose an L-shaped housing interior space 12. Possible embodiments of modular systems 100 include those that enable the selective provision of housings having cuboidal interior spaces 12 or interior spaces 12 that are delimited across the corners by the housing 10, for example L-shaped or U-shaped interior spaces 12.

The illustrated embodiments of the frames 20 form endoskeletons since the surface elements are fastened to the outside of frame elements. As an alternative, the frame can form an exoskeleton or corset, in which the surface elements 37 to 39 close an interior space 12 and against which the surface elements 37 to 39 are pushed to the outside in the case of an explosion.

According to the invention, a frame 20 for explosion-proof housings 10 is provided. The frame 20 is assembled from support elements 21. Preferably, square tubes are used as support elements 21, which are provided with elongated rectangular openings 27, which are preferably closed by flameproof grilles 31 that are welded on or fastened in another manner. The square tubes 21 of the embodiment are joined to form a skeletal frame 20, which supports the housing structure (support frame). Preferably metal plates 37 to 40 (for example stainless steel or aluminum), or also plastic plates, are fastened to the outside of the frame 20 by bonding and/or welding so that the housing 10 is closed. Venting openings 17, which can be closed by flameproof grilles 31, are preferably provided in suitable locations of the housing 10, such as at the bottom 15 or at the end faces 14. According to the invention, thin wall thicknesses of the surface elements 37 to 40, for example plates, as well as large housing dimensions, while ensuring a flameproof enclosure, are made possible by means of the supporting and stabilizing support frame 20, which also helps to reduce the pressure.

### LIST OF REFERENCE NUMERALS

| | |
|---|---|
| 10 | housing |
| 11 | surrounding area |
| 12 | housing interior space |
| 13 | longitudinal side |
| 14 | end face |
| 15 | bottom |
| 15a | bracing frame |
| 15b | bracing frame element |
| 16 | cover |
| 16a | bracing frame |
| 16b | bracing frame element |
| 17 | venting opening |
| 18 | pressure relief body |
| 20 | frame |
| 21 | support element |
| 21a | brace |
| 21b | bar |
| 22a | first plane/first frame section |
| 22b | second plane/second frame section |
| 24 | longitudinal sides |
| 25 | end faces |
| 26 | support element interior space |
| 27 | opening (interior space opening) |
| 28 | end-face connection opening |
| 29 | longitudinal-side connection opening |
| 30 | intermediate volume/flow channel |
| 30a | intermediate volume |
| 30b | intermediate volume |
| 31 | pressure relief body |
| 33 | wall |
| 36 | recess |
| 37 | surface element |
| 38 | surface element |
| 39 | surface element |
| 40 | surface element |
| 41 | seam, location |
| 42 | sealing seam |
| 43 | recess |
| 45 | flange |
| 46 | threaded bore |
| 47 | intermediate plate |
| 49 | edge region |
| 50 | connecting channel section |
| 50a | connecting channel section |
| 50b | connecting channel section |
| 51 | connecting web |
| 52 | section for screw joint |
| 53 | connecting section |
| 54 | connecting surface |
| 55 | connecting section |
| 56 | connecting surface |
| 60 | base material |
| 61 | reinforcement metal section |
| 62 | foot |
| 63 | flange section |
| 64 | sealing section |
| 65 | receiving section |
| 66 | form-fit section |
| 67 | sheet metal element |
| 68 | recessed bead |
| 69 | raised bead |
| 70 | sheet metal element |
| 71 | metal corner plate |
| 100 | modular system |
| 101 | first module |
| 102 | second module |
| 103 | third module |
| 104 | fourth module |
| 104a | first variant |
| 104b | second variant |
| 105 | fifth module |
| 200 | method |
| 201 | step |
| 202 | step |
| 203 | Step |
| L | longitudinal extension direction |

1. A frame for an explosion-proof housing enclosing a housing interior space for accommodating operating equipment that can produce sparks, wherein the frame comprises support elements, at least one of the support elements being a receiving support element and delimiting a support element interior space, and the receiving support element delimiting an opening by which the housing interior space is fluidically connected to the support element interior space.

2. The frame according to claim 1, wherein the support element interior space is one of a plurality of support element interior spaces defined by receiving support elements, the plurality of support element interior spaces being fluidically connected to one another by the support elements so that a gas exchange between the plurality of support element interior spaces is possible.

3. The frame according to claim 2, wherein the plurality of support element interior spaces connected to one another form a channel that is unbranched or branched once or branched multiple times.

4. The frame according to claim 1, wherein the frame and/or the housing establishes a venting opening by which the housing interior space is fluidically connected in a flameproof manner to a surrounding area of the housing.

5. The frame according to claim 4, wherein the housing interior space is fluidically connected in a flameproof manner to the surrounding area of the housing by the support element interior space and the venting opening.

6. A frame according to claim 4, wherein the venting opening is closed by a pressure relief body in a flameproof manner.

7. The frame according to claim 6, wherein the at least one of the support elements that has the opening one or at least one of the support elements that does not have the opening, establishes the venting opening.

8. A frame according to claim 1, wherein the support elements comprise a flameproof shell by way of which the support elements delimit the support element interior space transversely to a longitudinal extension direction of the support elements.

9. A frame according to claim 4, wherein the opening and/or the venting opening is closed by a pressure relief body in a flameproof manner, wherein the pressure relief body is a grille or a grille system.

10. An explosion-proof housing, comprising a frame according to claim 1.

11. The housing according to claim 10, wherein surface elements are fastened to the frame to close the housing.

12. The housing according to claim 11, wherein the surface elements are plate-shaped.

13. The housing according to claim 11, wherein the surface elements are welded and/or bonded to the frame.

14. A housing according to claim 11, wherein mutually abutting surface elements are joined to one another by welding or bonding.

15. The housing according claim 11, comprising a curved or folded plate for closing at least two sides of the housing which include an angle of 90 degrees.

16. A housing according to claim 11, wherein the frame and the surface elements are made of the same material.

17. A modular system for producing a frame according to claim 1.

18. A method for producing a frame, the frame including support elements, at least one of the support elements being a receiving support element and delimiting a support element interior space, and the receiving support element delimiting an opening by which the housing interior space is fluidically connected to the support element interior space, the method including the following steps: arranging the support elements to form the frame or at least a sub-structure of the frame, fastening the support elements, aligning the frame or the sub-structure of the frame, and connecting the support elements to fix an alignment of the frame or the sub-structure of the frame.

19. The frame according to claim 2, wherein the frame and/or the housing establishes a venting opening by which the housing interior space is fluidically connected in a flameproof manner to a surrounding area of the housing.

20. The frame according to claim 3, wherein the frame and/or the housing establishes a venting opening by which the housing interior space is fluidically connected in a flameproof manner to a surrounding area of the housing.
